(19) United States
(12) Patent Application Publication
(10) Pub. No.: US 2003/0005018 A1
(43) Pub. Date: Jan. 2, 2003

(54) Analog multiplication circuit

(75) Inventor: Shuhei Kawauchi, Sapporo-shi (JP)

Correspondence Address: SUGHRUE MION, PLLC, 2100 PENNSYLVANIA AVENUE, N.W., WASHINGTON, DC, 20037, US

(73) Assignee: A & CMOS, INC.

(21) Appl. No.: 10/184,992

(22) Filed: Jul. 1, 2002

(30) Foreign Application Priority Data
Jun. 29, 2001 (JP) 2001-199317

(51) Int. Cl. G06G 7/16

(52) U.S. Cl. 708/835

(57) ABSTRACT

An analog multiplication circuit for outputting an output multiplied by an input electric current with a predetermined number can be provided with a simple structure. The circuit comprises a gate voltage control portion 1 having a first operation amplifier 13 and a first MOSFET 14 operated in a MOS Ohmic region and at least one operation portion 3 having the second operation amplifier 32, a first resistance 31, an electric current mirror circuit 34 and a second MOSFET 33 operated in a MOS Ohmic region, wherein a first input electric current I1 is supplied to the first MOSFET 14 and a second input electric current I2 is supplied to the first resistance 31 so as to output an output electric current IOUT by multiplying I1 with I2 from an output-side transistor 36 of the electric mirror circuit 34.

### BACKGROUND OF THE INVENTION

1. Field of the Invention

The present invention relates to an analog multiplication circuit for multiplying an input electric current.

2. Discussion of the Related Art

For example, in the case of a temperature control of TCXO (temperature control crystal oscillator) and a ceramic oscillator, it is necessary to utilize a signal having temperature characteristic of a curve of the second order as shown A in FIG. 8 and a curve of the third order as shown B in FIG. 9.

In FIG. 8, three liner lines a, b and c having the different inclinations are provided so as to obtain a signal having the temperature characteristic A approximating the curve of the second order in FIG. 8. By switching the linear line at a respective intersection, a signal having a characteristic A′ can be obtained as an approximate line of the temperature characteristic A of the curvature of the second order.

In order to obtain a signal having the temperature characteristic B of the curvature of the third order as shown in FIG. 9, for example, three liner lines d, e, f having the different inclinations are provided for approximating the curvature as shown in FIG. 9. By switching the liner line at a respective intersection, a signal having a characteristic B can be obtained as an approximate line of the temperature characteristic B of the curvature of the third order.

However, in the case of approximating a characteristic of the curvature of N-order (N>2, integer number) by switching the characteristic of a liner line at each intersection, the characteristic of the curvature of the N-order is discontinuous at each intersection. At the both side regions adjacent to the intersection, a gap between the liner line and the curvature of the N-order would is relatively large so that an error could not be ignored.

In order to resolve the discontinuous and the error described above, it may increase number of liner lines for approximating the curvature. However, a structure of a circuit would become complicated.

### OBJECT AND SUMMARY OF THE INVENTION

To accomplish the above drawback, a purpose of the present invention is to provide an analog, multiplication circuit with a simple structure, wherein an input electric current is multiplied by a predetermined number and a multiplied output is continuously adjusted by reducing an error caused by a characteristic of a polynomial expression.

To accomplish the above purpose, an analog multiplication circuit comprises a gate voltage control portion including a first MOSFET and a first operation amplifier, the first MOSFET having a first main electrode connected to a first battery terminal, a second main electrode connected to one of input terminals of the first operation amplifier and a gate electrode connected to an output terminal of the first operation amplifier, wherein the first MOSFET is operated in a MOS Ohmic region in accordance with a voltage between the first battery terminal and the other of the input terminals of the first operation amplifier; and at least one operation portion comprising a second MOSFET, a second operation amplifier, and a first resistance and an electric current mirror circuit having a pair of transistors of which each control electrode is commonly connected, the second MOSFET having a first main electrode connected to a first battery terminal, a second main electrode connected to one of input terminals of the second operation amplifier and a gate electrode connected to an output terminal of the first operation amplifier of the gate control portion, wherein the first resistance is provided at a point between the other of the input terminals of the second operation amplifier and the first battery terminal and an output terminal of the second operation amplifier is connected to the control electrodes of the pair of transistors of the electric current mirror circuit, wherein the circuit is characterized in that the first input electric current is supplied to a path between the first and second main electrodes, the second main electrode of the first MOSFET and the input electric current is supplied to the first resistance and the first input electric current is multiplied with the second input electric current in the electric current mirror circuit so as to output an output electric current.

In accordance with the first aspect of the present invention, the gate voltage control portion including the first operation amplifier and the first MOSFET operated in the MOS Ohmic region and at leas one operation portion including the second operation amplifier, the first resistance, an electric current mirror circuit and the second MOSFET operated in the MOS Ohmic region can be formed by a simple structure. The second operation amplifier adjusts the control voltage of the pair of transistors of the electric current mirror circuit so as to equal the both input voltages so that a value of an output electric current is obtained by multiplying the first input electric current I1 and the second input electric current from the output transistor of the electric current mirror circuit. In the case of I1=I2, the output electric current is I1². If the input electric current has a linear temperature characteristic, the output electric current is in proportion to square temperature. In the present specification, MOSFET means a known MOS type field effect transistor (FET).

The second aspect of the present invention is characterized of further comprising another gate voltage control portion and another operation portion in addition to the circuit as described above, wherein a gate electrode of the second MOSFET of the first operation portion is connected to an output terminal of the first operation amplifier of the first gate voltage control portion, a gate electrode of the second MOSFET of the second operation portion is connected to an output terminal of the first operation amplifier of the second gate voltage control portion and an output electric current of the electric mirror circuit of the operation portion is supplied into the first resistance of the second operation portion, a first input electric current in supplied to a path between a first main electrode and the second main electrode of the first MOSFET of the first gate voltage control portion, a second input electric current is supplied to the first resistance of the first operation portion and a third input electric current is supplied to a path between the main electrode and the second main electrode of the first MOSFET of the second gate voltage control portion so that the first input electric current, the second input electric current and the third input electric current are multiplied so as to output an output electric current.

Regarding the second aspect of the present invention, two sets of the gate voltage control portions and operation portions are formed in a simple structure. The control voltages of the pair of transistors of the electric mirror circuit of the first operation portion are adjusted by the second operation amplifier of the second operation so as to equal the both input voltage and control voltages of the pair of the transistors of the electric mirror circuit of the second operation portion are controlled so that an output electric current obtained by multiplying the input electric current I1, the second input electric current I2 and the third input electric current I3 from the output transistor of the electric current mirror circuit of the second operation. In the case of I1=I2, I2=I3 or I3=I1, the output electric current of I1²×I3, I2²×I1 or I3²×I1 can be obtained. In the case of I1=I2=I3, the output electric current of I1³ can be obtained. If the input electric current has a linear temperature characteristic, the output electric current is in proportion to cube temperature (T³).

The third aspect of the present invention is characterized in that the operation portion is formed by a multi-stop formation, wherein an output electric current from the electric mirror circuit of a former step operation portion is supplied to a first resistance of a next step operation portion and the first input electric current is raised to the several power and an output electric current is output from the last step operation portion.

The circuit has a simple structure in which a plurality of operation portions are successively connected in a multi step formation so that output electric current by raised to the several power of the input electric current is output from an electric current mirror circuit of the last operation portion. If the input electric current has a linear temperature characteristic, the output electric current is in proportion to power of temperature (Tⁿ).

The fourth aspect of the present invention is characterized in that the operation portion is formed by a multi-step formation in the circuit as described above, wherein an output electric current from the electric mirror circuit of a former step operation portion is supplied to a first resistance of a next operation portion and the analog multiplication circuit further comprising an adder circuit for adding output electric current from each step operation portion so as to output a solution of polynomial expression with respect to the first input electric current from the adder circuit.

The circuit is a simple structure in which a plurality of operation portions are successively connected in series and an output of each operation portion is added in the adder circuit. An output as a solution of a polynomial expression with respect to the first input electric current can be obtained. If the input electric current has a linearly temperature characteristic, it can be obtained an output in proportion to the polynomial expression with respect to temperature. Particularly, in order to obtain the output of the polynomial expression as an electric current output, the output electric current of each operation portion can be added by merely shorting the electric current output wire of the each operation portion.

The fifth aspect of the present invention is characterized in that the gate voltage control portion comprises a second resistance and a battery source which are connected in series between the first battery terminal and the second battery terminal and the other of input terminals of the first operation amplifier of the gate voltage control portion is connected to a connecting point between the second resistance and the battery source.

The temperature characteristic of the first and second resistance can be canceled by utilizing the second resistance of the gate voltage control portion and the first resistant of the operation portion having the same characteristic Therefore, a low-priced resistance having a temperature characteristic can be utilized as the first and second resistances.

The sixth aspect of the present invention is characterized in that the gate voltage control portion comprises a battery source connected to a point between the other of input terminals of the first operation amplifier and the first battery terminal of the gate voltage control portion

The gate voltage of the first MOSFET of the gate voltage control portion is obtained by a voltage source.

The seventh aspect of the present invention is characterized in that the pair of transistors of the electric current mirror circuit of the operation portion are MOSFET.

The pair of the transistor of the electric current mirror circuit of the operation portion is MOSFET, respectively so that the first MOSFET of the gate voltage control portion and the second MOFET of the operation portion are formed on the same substrate of a semiconductor.

The eighth aspect of the present invention is characterized in that the first MOSFET of the gate voltage control portion and the second MOSFET of the operation portion are p-channel type MOSFETs and the pair of MOSFET of the electric current mirror circuit of the operation portion are n-channel type MOSFETs.

The first and second MOSFETs controlled by the first operation amplifier of the gate voltage control portion is p-channel type and the pair of MOSFETs of the electric mirror channel controlled by the second operation amplifier of the operation portion is n-channel type so that a structure of the circuit can be simplified.

The ninth aspect of the present invention is Characterized in that the first MOSFET of the gate voltage control portion and the second MOSFET of the operation portion are n-channel type MOSFETs and the pair of MOSFET of the electric current mirror circuit of the operation portion are p-channel type MOSFETs.

The first and second MOSFETs controlled by the first operation amplifier of the gate voltage control portion is n-channel type and the pair of the MOSFETs of the electric current mirror circuit controlled by the second operation amplifier of the operation portion is p-channel so that the structure of the circuit can be simplified.

The tenth aspect of the present invention as claimed is characterized in that at least the first MOSFET and the operation amplifier of the gate voltage control portion and the second MOSFET, the second operation amplifier and the pair of MOSFETs in the electric current mirror circuit of the operation portion are formed in the same substrate of a semiconductor.

At least the first MOSFET, the first operation amplifier, the second MOSFET, the second operation amplifier and the electric mirror circuit can be formed on the same substrate of a semiconductor so that the whole structure of the multiplication circuit can be down sized.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows an analog multiplication circuit of the first embodiment according to the present invention;

FIG. 2 shows a circuit of the second embodiment according to the present invention;

FIG. 3 shows a circuit of the third embodiment according to the present invention;

FIG. 4 shows a circuit of the fourth embodiment according to the present invention;

FIG. 5 shows another gate voltage control portion of an analog multiplication circuit according to the present invention;

FIG. 6 shows another circuit according to the present invention;

FIG. 7 shows another circuit according to the present invention;

FIG. 8 is a drawing for explaining a method how a curvature of the second order is approximated with three liens; and

FIG. 9 is a drawing for explaining a method how a curvature of the third order is approximated with three lines.

### DETAILED DESCRIPTION OF THE INVENTION

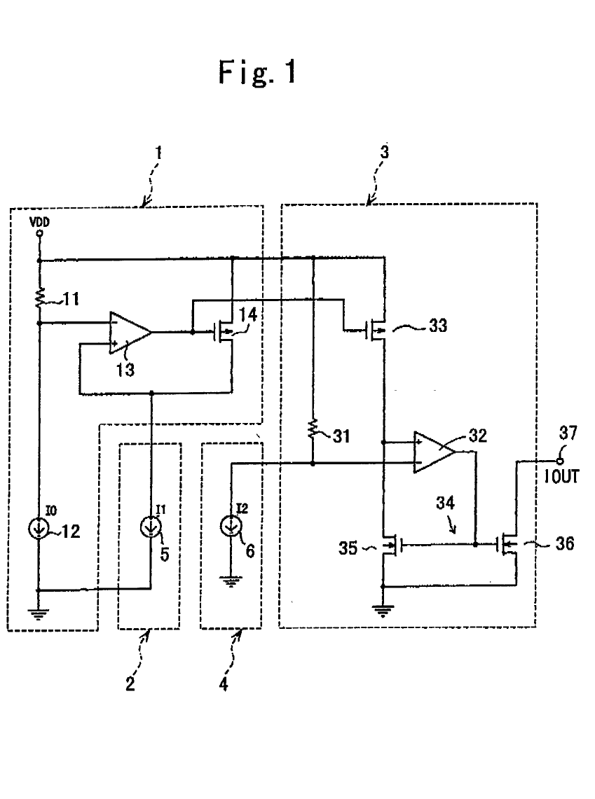

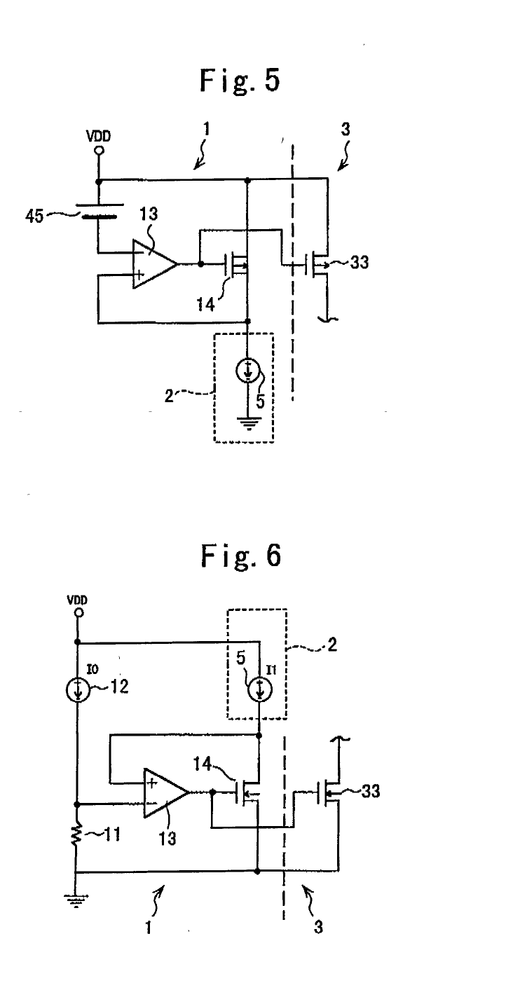

Embodiments of an analog multiplication circuit according to the present invention will be described with reference to FIGS. 1 through 7.

(The First Embodiment)

FIG. 1 shows a structure of a circuit of the first embodiment according to the present invention. The analog multiplication circuit comprises a gate voltage control portion 1, a first input portion 2, an operating portion 3 and a second input portion 4.

The gate voltage control portion 1 includes a resistance (a second resistance) I1, a battery source I2, an operation amplifier (a first operation amplifier) 13 and p-channel type MOSFET (a first MOSFET) 14.

The resistance I1 has one terminal connected to a VDD (as the first battery source terminal) and the other terminal connected to the ground (the second battery source terminal) and a reverse input terminal of the operation amplifier 13. The MOSFET 14 has a source electrode (as the first main electrode) connected to the VDD, a drain electrode (as the second main electrode) connected to the non-reverse input terminal of the operation amplifier 13 and a gate electrode connected to an output terminal of the operation amplifier 13.

The first input portion 2 is formed at a portion between the drain electrode of the MOSFET 14 and the ground in the gate voltage control portion. The first input battery source 5 is connected to the first input portion 2 so as to supply an first input electric current I1 having an optional characteristic to a path between the drain and the MOSFET 14.

The operation portion 3 includes a resistance (the first resistance) 31, an operation amplifier (the second operation amplifier) 32, a p-channel type MOSFET (the second MOSFET) 33 and an electric current mirror circuit 34. The electric current mirror circuit 34 has a pair of n-channel type MOSFETs 35 and 36.

One terminal of the resistance 31 is connected to a VDD and the other terminal is connected to a reverse input terminal of the operation amplifier 32. In the MOSFET 33, a source electrode (the first main electrode) is connected to the VDD, a drain electrode (the second main electrode) is connected to a non-reverse input terminal of the operation amplifier 32 and the ground through a path between the drain and the source of the input MOSFET 35 of the electric current mirror circuit 34. An output terminal of the operation amplifier 32 is connected to a gate electrode of the MOSFETS 35 and 36 of the electric mirror circuit 34. The output electric current IOUT is taken from an output terminal 37 connected to the drain electrode of the output MOSFET 36 of the electric mirror circuit 34.

The second input portion 4 is formed at a portion between the other terminal of the resistance 31 of the operation portion 3 and the ground so as to supply a second input electric current I2 having an optional characteristic to the resistance 31 by connecting the second input battery source 6 and the second input portion 4.

At least the operation amplifier 13 and MOSFET 14 of the gate voltage control portion 1 and the operation amplifier 32, MOSFET 33 and the electric mirror circuit 34 of the operation portion 3 are formed on the same substrate of a semiconductor.

Under the structure described above, a voltage (R11×I0) between a resistance I1 and an electric current (I0) of the battery source I2 in the gate voltage control-portion is determined a preferable level, i.e. 0.1V˜0.2V so as to actuate the MOSFETs 14 and 33 controlled by the operation amplifier 13 and the second input electric current I2 is determined so as to operate the MOSFET 33 in the MOS Ohmic region.

Under the condition, in the case of the resistant value of the MOSFET 14 is R14, the resistance (R11) of the gate voltage control portion 1 to which the first input electric current I1 is input is satisfied with the following equation in accordance with a function of the operation amplifier 13.

R11×I0=R14×I1 (1)

In the operation portion 3 to which the second input electric current is input, the operation amplifier 32 makes the both input voltage values equivalent in accordance with a function of the operation amplifier 32, that is, the gate voltages of a pair of the MOSFET 35 and 36 of the electric current mirror circuit 34 are controlled. In the case that a resistant value of the MOSFET 33 is R33 and a drain electric current of the input side MOSFET 35 of the electric current mirror circuit 34 is ID, the following equation is satisfied.

R21×I2=R33×ID35 (2)

In the case that the drain electric current in the output side MOSFET 36 of the electric current mirror circuit 34 is ID36, the output electric current IOUT taken from the output terminal 37 of the operation portion 3 is satisfied with the following equation.

IOUT=ID36 (3)

If the transistor size of the input MOSFET 35 and the output MOSFET 36 is adjusted, respectively so as to equal the drain electric current (ID35) of the input MOSFET 35 and the drain electric current (ID36) of the output MOSFET 36 in the electric mirror circuit 34, the following equation is satisfied in accordance with the equations (2) and (3):

IOUT=R31×I2÷R33 (4)

If the transistor size of the MOSFET 14 and the MOSFET 33 is adjusted, respectively so as to equal the resistant value (R14) of the MOSFET 14 and the resistant value (R33) of the MOSFET 33, the following equation is satisfied in accordance with the equations (1) and (4):

IOUT=R31×I2÷(R11×I0÷I1) (5)

If the resistance values R11 and R31 are equal, the following equation can be obtained.

IOUT=I1×I2÷I0 (6)

Accordingly, in the case that the value I0 is constant, the value of IOUT is amount of I1×I2. In the case of I1=I2, the vale of IOUT is I1². In the case of I1=I2=kT (electric current having a linearly temperature characteristic, T=temperature [°C.], k=constant number), the value of IOUT is an amount corresponding to suqare temperature (T²).

The circuit according to the present invention has a simple structure and comprises the gate voltage control portion 1 including the resistance I1, the battery source I2, the operation amplifier 13 and MOSFET 14 operated in the MOS Ohmic region and the operation portion 3 including the resistant 31, the operation amplifier 32, MOSFET 33 operated in the MOS Ohmic region and the electric current mirror circuit 34. When the first input electric current I1 and the second input electric current I2 is input to MOSFET 14 and the resistance 31, respectively and the operation amplifier 32 controls the gate voltage of the pair of the MOSFETs 35 and 36 of the electric current mirror circuit 34 so as to be equal the both input voltage values, the output electric current is output through the output terminal and its amount is obtained by multiplying the first input electric current with the second input electric current (I1×I2). If the values of I1 and I2 are equal, the output electric current is square current (I1²). If the input electric current has a linearly temperature characteristic, the output electric current is in proportion to square temperature

In the case that the MOSFETs 14 and 33 controlled by the operation amplifier 13 in the gate voltage control portion 1 is a p-channel type and the pair of MOSFETs 35 and 36 of the electric current mirror circuit 34 controlled by the operation amplifier 32 in the operation portion 3 is a n-channel type, a structure of the circuit can be simplified. At least the operation amplifier 13 and MOSFET 14 of the gate voltage control portion 1 and the operation amplifier 32, MOSFET 33 and the pair of MOSFETs 35 and 36 of the electric mirror circuit 34 of the operation portion 3 are formed on the same substrate of the semiconductor so that the multiplication circuit can be concentrated and down sized.

(The Second Embodiment)

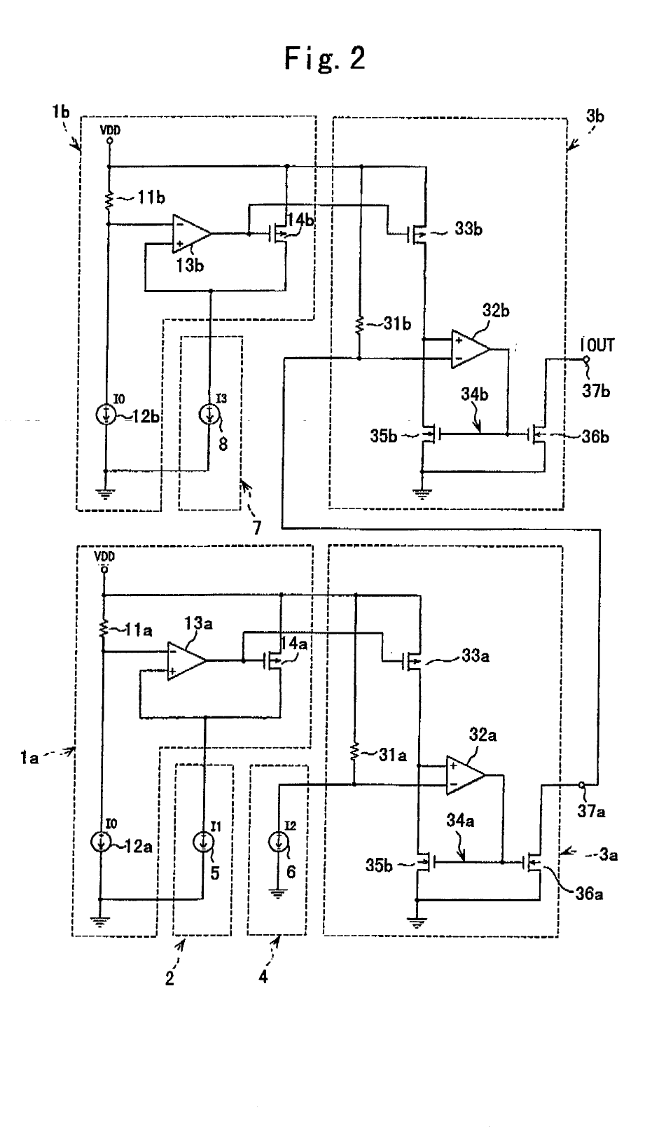

FIG. 2 shows an analog multiplication circuit of the second embodiment according to the present invention. The second embodiment comprises a first operation portion 3a and a second operation portion 3b wherein a first input electric current I1, a second input electric current I2 and a third input electric current I3 are multiplied.

The first gate voltage control portion 1a and the second gate voltage control portion has the same structure of the gate voltage control portion 1 of the first embodiment described before, respectively. The first operation portion 3a and the second operation portion 3b also has the same structure of the operation portion 3 of the first embodiment as described before, respectively. In FIG. 2, the same numerals are applied to components of the first gate voltage control portions 1a and 1b of the second embodiment corresponding to those of the gate voltage control portion 1 of the first embodiment as shown in FIG. 1. Further, suffixes a and b are applied in order to distinguish the first gate voltage control portion 1a and the first gate voltage control portion 1b, respectively. Therefore, the detailed description thereof is omitted.

In FIG. 2, the first gate voltage portion 1a, the first input portion 2, the first operation portion 3a and the second input portion 4 are connected as similar as the arrangement as shown in FIG. 1. The first input electric current I1 is supplied from the first input battery source 5 connected to the first input portion 2 and the second input electric current I2 is supplied from the second input battery source 6 connected to the second input portion 4.

The second gate voltage control portion 1b and the second operation portion 3b are connected as similar as the arrangement as shown in FIG. 1. The third input battery source 8 is connected to the third input portion 7 at a point between a source electrode of the MOSFET 14b of the second gate voltage control portion 1b and the ground. The third input electric current I3 having an optional characteristic is supplied to a drain source path of the MOSFET 14b. The output electric current Ia of the first operation portion 3a is supplied to a resistance 31b of the second operation portion 3b.

In the second embodiment, the output electric current Ia obtained from an output terminal 37a of the first operation portion 3a is satisfied with the following equation as similar as the first embodiment.

Ia=I1×I2÷I0 (7),

wherein I0 is an electric current of the battery source 12a.

The output electric current IOUT obtained from a output terminal 37b of the second operation portion 3b is equal to a resistant value of the resistance 11b of the second gate voltage control portion 1b and the a resistant value of the resistance 31b of the second operation portion 3b. The resistant values of the MOSFET 14b of the second gate voltage control portion 1b and the MOSFET 33b of the second operation portion 3b are equal. Under the above condition, the following equation is satisfied:

IOUT=I3×Ia÷I0′ (8),

wherein I0′ is an electric current of a battery source 12b of the second gate voltage control portion 1b. By combining the equations (7) and (8), the following equation can be obtained.

IOUT=I1×I2×I3÷I0÷I0′ (9)

Accordingly, if the values of I0 and I0′ are constant, the output value can be obtained by multiplying I1, I2 and I3.

If one pair out of three input electric currents are equal (I1=I2, I2=I3 or I3=I1), the output value is I1²×I3, I2²×I1 or I3²×I2. If the all input electric currents are equal (I1=I2=I3), the output electric current is I1³. If the input electric current has a linearly temperature characteristic, the output electric current is corresponding to cube temperature (T³).

The circuit of the second embodiment according to the present invention has a simple structure having the first and second gate voltage control portions 1a and 1b and the second operation portions 3a and 3b. The output electric current is obtained by multiplying input electric currents I1, I2 and I3 (I1×I2×I3).

In FIG. 2, extra voltage control portions and operation portions can be provided additionally. If an input electric current is supplied to each gate voltage control and an output electric current of the former operation portion is input to the next operation portion in order, an output from the last operation portion is obtained by multiplying the all input electric current (I1×I2×I3×I4× . . . ×In).

(The Third Embodiment)

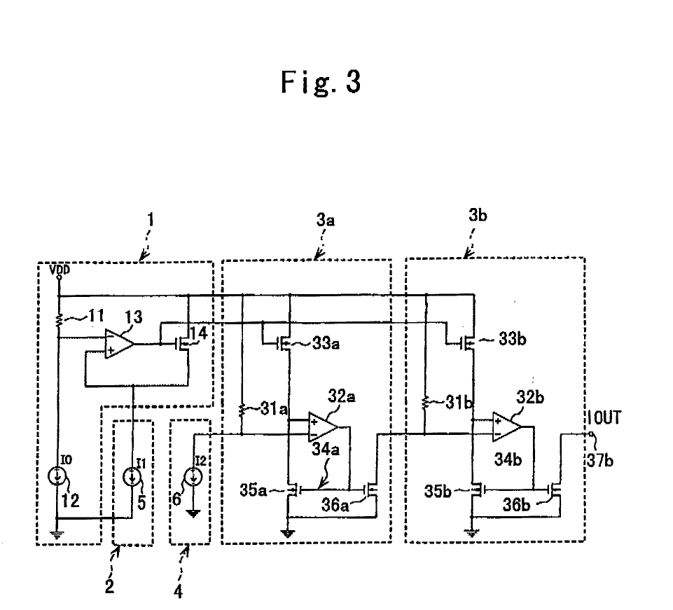

FIG. 3 shows an analog multiplication circuit of the third embodiment according to the present invention. In the third embodiment another operation portion is added to the circuit as shown in FIG. 1. In order to understand easily, a former operation portion is designated as the first operation portion 3a having the same function of the operation portion 3 as shown in FIG. 1 in which the same numeral is applied to the components corresponding to the components of the operation portion 3a and a suffix a is added with each numeral in the first operation portion. The latter operation portion is designated as the second operation portion 3b and a suffix b is added to each numeral in the second operation portion 3b. Therefore, the detailed description thereof is omitted.

In the second operation portion 3b, a gate electrode of the MOSFET 33b is connected to an output terminal of the operation amplifier 13 of the gate voltage electrode 1 and an output electric current Ia of the first operation portion 3a is supplied to a resistance 31b.

Under the structure, as similar as the first embodiment, in the gate voltage control portion 1, the following equations are satisfied in the first operation portion 3a and the second operation portion 3b.

R11×I0=R14×I1 (1)

R31a×I2=R33a×ID35a (10)

R31b×ID36a=R33b×ID33b (11)

An output electric current IOUT from an output terminal 37b of the second operation portion 3b is as follows:

IOUT=ID36b (12)

In the second amplifier 3b, if the transistor size of the MOSFET 35b and that of the MOSFET 36b are adjusted to be equal ID35b and ID36b, the following equation is introduced from the equations (12) and (11).

In the first operation portion 3a, if the transistor size of the MOSFET 35a and that of the MOSFET 36a are adjusted to be equal ID35a and ID36a, the following equation is introduced from equations (13) and (10).

IOUT=R31b÷R33b×R31a×I2÷R33a (14)

If the transistor size of resistances 14, 33a and 33b is adjusted individually so as to be equal to the all resistance values of R14, R33a and R33b, the following equation can be obtained from the equations (14) and (1).

IOUT=R31b×R31a×I2÷(R11×I0÷I1)² (15)

Further, if the resistances I1, 31a and 31b are adjusted so as to be equal R11, R31a and R31b, the following equation can be obtained.

IOUT=I1²×I2÷I0² (16)

Accordingly, the output electric current of I1²×I2 can be obtained from the output terminal 37b. If the values of I1 and I2 are equal, the output electric current is I1³. If the values of I1 and I2 is kT, the output electric current is in proportion to cube temperature (T³). If multiple (n) operation portions are successively connected, a value of the output electric current is indicated as I1ⁿ.

(The Fourth Embodiment)

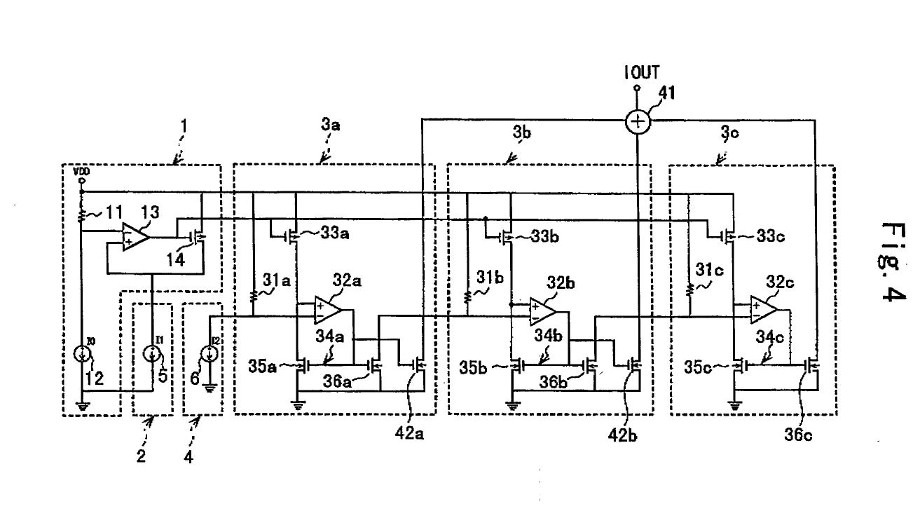

FIG. 4 shows an analog multiplication circuit of the fourth embodiment according to the present invention. In the fourth embodiment, the third operation portion 3c is provided at a rear side of the second operation portion 3b of the structure as shown in FIG. 3. An output electric current Ib of the second operation portion 3b is supplied to a resistance 31c of the third operation portion 3c. An output electric current Ia of the first operation portion 3a, an output electric current Ib of the second operation portion 3b and an output electric current Ic of the third operation portion 3c are supplied to an adder circuit 41. In the third operation portion 3c, the same numeral is applied to each component corresponding to the same component of the operation portion 3 as shown in FIG. 1 and a suffix c is added with the respective numeral. Therefore, the detailed description thereof is omitted.

As similar as the gate electrodes of the MOSFETs 33a and 33b of the first and second operation portions 2a and 2b, a gate electrode of the MOSFET 38c of the third operation portion 3c is connected to an output terminal of an operation amplifier 13 of the gate voltage control portion 1. The output electric current Ia and Ib of the first and second operation portions 3a and 3b supplied to the adder circuit 41 is taken from the output MOSFETs 42a and 42b, respectively. An output electric current Ic is taken from MOSFET 36c in an electric current mirror circuit 34c of the third operation portion 3c. A gate electrode of the MOSFET 42a is connected to an output terminal of the operation amplifier 32a of the first operation portion 3a and a gate electrode of the MOSFET 42b is connected to an output terminal of the operation amplifier 32b of the second operation portion 3b.

Under the above structure, as similar as the embodiments as described above, the transistor size of the MOSFTs 35a, 36a; 35b, 36b; 35c, 36c of the electric current mirror circuits 34a, 34b and 34c of the each operation portions are adjusted individually so as to be satisfied with the equations, ID35a=ID36a, ID35b=ID36b and ID35c=ID36c, the transistor size of the MOSFET 14 of the gate voltage control portion 1 and the MOSFETs 33a through 33c of the first through third operation portions 3a through 3c are adjusted individually so as to be satisfied with an equation, R14=R33a=R33b=R33c, and a resistance value of R11 of the gate voltage control portion 1 and resistance values R31a through R31c of the resistances 31a through 31c of the first through third operation portions 3a through 3c are adjusted individually so as to be satisfied with an equation, R11=R31a=R31b=R31c, it can be obtained an output electric current from the adder circuit 41 as described below in the case that I1 is not equivalent of I2.

IOUT=(I1³+I1²+I1)×I2

That is, IOUT is a solution of the polynomial (three-ordered) expression with respect to I1. In the case that I1 is equivalent of I2, the following equation is satisfied.

IOUT=I1⁴+I1³+I1²

That is, the output electric current IOUT is a solution of the polynomial (fourth-ordered) expression with respect to I1. If the input electric current has a linearly temperature characteristic, the output electric current has a characteristic corresponding to the polynomial (three- or four-ordered) expression with respect to temperature T.

The fourth embodiment according to the present invention has a simple structure in which the first through third operation portions 3a through 3c are successively connected to one gate voltage control portion 1 and the output of each operation portion is added in the adder circuit 41. Under the structure, the output electric current IOUT is a solution of polynomial (three- or four-ordered) expression with respect to the input electric current I1 and has a characteristic of the polynomial (three- or four-ordered) expression with respect to the temperature T. Thus, the output electric current can be continuously adjusted so as to reduce an error with respect to the characteristic of the polynomial expression. The electric current output is a solution of the polynomial expression so that the output electric current of each operation portion can be added by merely shorting electric current output wires connected to the drain electrodes of the MOSFET 42a, 42b and MOSFET 36c, respectively. The adder circuit 41 is easily formed.

In the fourth embodiment, although three operation portions are successively connected, it may be an arrangement in which two operation portions are connected so as to obtain an output electric current as the solution of the second- or three-ordered expression and the output electric current having the characteristic corresponding to the solution of the second- or three-ordered expression with respect to temperature T. Alternatively, four or more than operation portions may be successively connected so as to obtain an output electric current as a solution of four- or five-ordered expression and an output electric current having a characteristic corresponding to a solution of the four- or five-ordered expression with respect to temperature T.

The present invention is not limited to the embodiments as described above. It may be adjustable within an essence of the present invention. For example, although a voltage applied to the MOSFET 14 of the gate voltage control portion 1 is obtained by the resistance 11 and the battery source in the embodiments as described above, a battery source 45 may be connected to a point between a reverse input terminal of the operation amplifier 13 and the VDD.

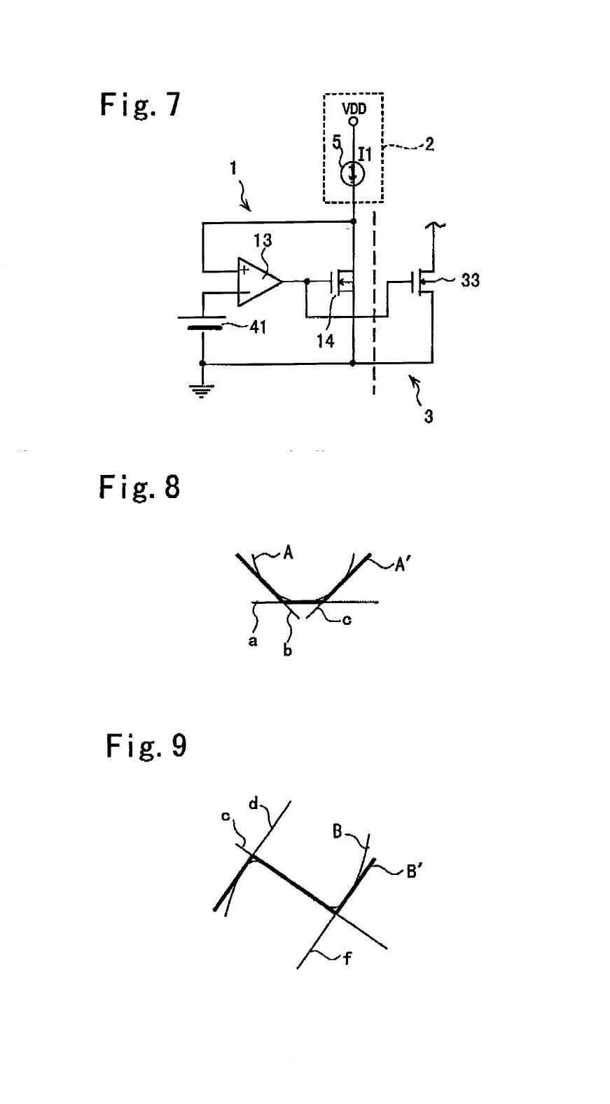

The MOSFET controlled by the operation amplifier 13 of the gate voltage control portion 1 in the MOS Ohmic region may be an n-channel type MOSFET. For example, as shown in FIGS. 6 and 7, the gate voltage control portion 1 may have an arrangement in which VDD is the second battery terminal, the ground is the first battery source, a drain electrode of the MOSFET 14 is connected to a non-reverse input terminal of the operation amplifier 13 and the source electrode is grounded by connecting to VDD through the input battery source 12 for producing the input electric current I1. In FIG. 6, a gate electrode is obtained by the resistant I1 and the battery source 12. In FIG. 7, a gate voltage is obtained from a battery source 45. In the case of the n-channel type MOSFET operated in the MOS Ohmic region, it is preferable that the pair of MOSFETS 35 and 36 in the electric mirror circuit 34 of the operation portion 3 are p-channel type.

As an output electric current as a solution of polynomial expression, it may not add the output electric current of each operation portion to an adder circuit along the same direction. A direction of an output electric current of an operation portion in any step may be reverse by adding an electric mirror circuit and add to the adder circuit 41 with an electric output wire. Under the condition, for example, in the case that a direction of the output electric current from the operation portion 3b in an intermediate step as shown in FIG. 4, the following output electric current can be obtained from the adder circuit 41.

IOUT=(Il³−II²+Il)×I2

Or

IOUT=I1⁴−I1³+I1²

Instead of reversing the direction of an output electric current by providing an electric mirror circuit, the adder circuit 41 may calculate the output electric current including a reverse directed electric current by providing an operation portion including a p-channel type MOSFET operated in the MOS Ohmic region and a pair of n-channel type MOSFETs in an electric current mirror circuit and an operation portion including a n-channel type MOSFET operating in the MOS Ohmic region and a pair of p-channel type MOSFETs in an electric current mirror circuit.

A ratio of electric current in the pair of the MOSFETs in the electric current mirror circuit of an operation portion may be determined optional in addition to the ratio of 1:1. For example, any ratio of electric current can be determined by changing the sizes of the transistors individually. Thus, the output electric current may be weighted.

A multiplication result of the input electric current (power of number, solution of polynomial) is not only the output electric current but also the output voltage by converting electric current to voltage.

An electric current mirror circuit of an operation portion is not only MOSFET but also a bi-polar transistor.

As described above, a circuit according to the present invention comprise at least a gate voltage control portion having a first operation amplifier and a first MOSFET operated in a MOS Ohmic region and an operation portion having a second operation amplifier, a first resistant, an electric current mirror circuit and a second MOSFET operated in a MOS Ohmic region, wherein a first input electric, current and a second input electric current is supplied to the first MOSFET and the first resistance, respectively and an output electric current multiplied by the first input electric current and the second input electric current is output from an output side of the electric current mirror circuit. In the case that I1 is equal to I2, the output electric current of I1² can be obtained. If the input electric current has a linearly temperature characteristic, the output electric current is proportional to square temperature (T²).

The circuit according present invention provide an output as a solution of the polynomial expression with respect to the first input electric current with a simple structure wherein multi operation portions are successively connected to one gate voltage control portion. If the input electric current has a linearly temperature characteristic, the output is in proportion to the solution of a polynomial expression with respect to temperature so that the characteristic indicating the polynomial can be continuously adjusted so as to reduce an error.

For example, the present invention can be applied to a temperature control of TCXO, a ceramic oscillator and so on since a signal having a temperature characteristic appeared by the second- or third-ordered function. The operation can be actuated at a real time so that the present invention also can be applied to a system for controlling a robot capable of walling with two legs, wherein outputs of sensors of the robot are immediately operated.

The entire disclosure of Japanese Patent Application No.2001-199317 filed on Jun. 29, 2001 including specification, claims, drawings and summary is incorporated herein by reference in its entirety.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

What is claimed is:

1. An analog multiplication circuit comprising:
gate voltage control means including:
a first MOSFET and
a first operational amplifier,
said first MOSFET having a first main electrode connected to a first battery terminal, a second main electrode connected to one of input terminals of said first operational amplifier and a gate electrode connected to an output terminal of said first operational amplifier, wherein said first MOSFET is operated in a MOS Ohmic region in accordance with a voltage between said first battery terminal and the other of said input terminals of said first operational amplifier; and
at least one operational means comprising:
a second MOSFET,
a second operational amplifier, and
a first resistance and
an electric current mirror circuit having a pair of transistors of which each control electrode is commonly connected,
said second MOSFET having a first main electrode connected to a first battery terminal, a second main electrode connected to one of input terminals of said second operational amplifier and a gate electrode connected to an output terminal of said first operational amplifier of said gate control means, wherein said first resistance is provided at a point between the other of said input terminals of said second operational amplifier and said first battery terminal and an output terminal of said second operational amplifier is connected to the control electrodes of said pair of transistors of said electric current mirror circuit,
wherein said circuit is characterized in that the first input electric current is supplied to a path between said first and second main electrodes, said second main electrode of said first MOSFET and said input electric current is supplied to said first resistance and said first input electric current is multiplied with said second input electric current in said electric current mirror circuit so as to output an output electric current.

2. The analog multiplication circuit as claimed in claim 1 characterized of further comprising another gate voltage control means and another operational means, wherein a gate electrode of the second MOSFET of the first operational means is connected to an output terminal of the first operational amplifier of the first gate voltage control means, a gate electrode of the second MOSFET of the second operational means is connected to an output terminal of the first operational amplifier of the second gate voltage control means and an output electric current of the electric mirror circuit of said operational means is supplied into the first resistance of the second operational means,
a first input electric current in supplied to a path between a first main electrode and the second main electrode of the first MOSFET of the first gate voltage control means, a second input electric current is supplied to the first resistance of the first operational means and a third input electric current is supplied to a path between the main electrode and the second main electrode of the first MOSFET of the second gate voltage control means so that said first input electric current, said second input electric current and the third input electric current are multiplied so as to output an output electric current.

3. The analog multiplication circuit as claimed in claim 1 characterized in that said operational means is formed by a multi-step formation, wherein an output electric current from the electric mirror circuit of former step operational means is supplied to a first resistance of next step operational means and said first input electric current is raised to the several power and an output electric current is output from the last step operational means.

4. The analog multiplication circuit as claimed in claim 1 characterized in that said operational means is formed by a multi-step formation, wherein an output electric current from the electric mirror circuit of a former step operational means is supplied to a first resistance of next operational means and said analog multiplication circuit further comprising an adder circuit for adding output electric current from each step operational means so as to output a solution of polynomial expression with respect to said first input electric current from said adder circuit.

5. The analog multiplication circuit as claimed in one of claims 1 through 4, wherein said gate voltage control means comprises a second resistance and a battery source which are connected in series between said first battery terminal and the second battery terminal and the other of input terminals of said first operational amplifier of said gate voltage control means is connected to a connecting point between said second resistance and said battery source.

6. The analog multiplication circuit as claimed in one of claims 1 through 4 characterized in that said gate voltage control means comprises a battery source connected to a point between the other of input terminals of said first operational amplifier and the first battery terminal of the said gate voltage control means.

7. The analog multiplication circuit as claimed in one of claims 1 through 6 characterized in that said pair of transistors of said electric current mirror circuit of said operational means are MOSFET.

8. The analog multiplication circuit as claimed in claim 7 characterized in that said first MOSFET of said gate voltage control means and said second MOSFET of said operational means are p-channel type MOSFETs and said pair of MOSFET of said electric current mirror circuit of said operational means are n-channel type MOSFETs.

9. The analog multiplication circuit as claimed in claim 7 characterized in that said first MOSFET of said gate voltage control means and said second MOSFET of said operational means are n-channel type MOSFETs and said pair of MOSFET of said electric current mirror circuit of said operational means are p-channel type MOSFETs.

10. The analog multiplication circuit as claimed in claim 8 or 9 characterized in that at least said first MOSFET and said operational amplifier of said gate voltage control means and said second MOSFET, said second operational amplifier and said pair of MOSFETs in said electric current mirror circuit of said operational means are formed in the same substrate of a semiconductor.
